(19) United States
(12) Patent Application Publication
(10) Pub. No.: US 2026/0284648 A1
(43) Pub. Date: Sep. 24, 2026

(54) ARRANGEMENT AND METHOD FOR CATALYSING AT LEAST TWO REACTIONS, THROUGHFLOW REACTOR, AND USES OF THE ARRANGEMENT AND OF THE THROUGHFLOW REACTOR

(71) Applicant: FRAUNHOFER-GESELLSCHAFT ZUR FÖRDERUNG DER ANGEWANDTEN FORSCHUNG E.V., München (DE)

(72) Inventors: Thomas REHM, Mainz (DE); Michaela MÜLLER, Stuttgart (DE); Jakob Philipp BARZ, Stuttgart (DE); Bettina HERBIG, Würzburg (DE); Claudia STAUCH, Würzburg (DE); Greta NÖLKE, Aachen (DE); Stefano DI FIORE, Aachen (DE)

(73) Assignee: FRAUNHOFER-GESELLSCHAFT ZUR FÖRDERUNG DER ANGEWANDTEN FORSCHUNG E.V., München (DE)

(21) Appl. No.: 19/474,523

(22) PCT Filed: Mar. 22, 2024
(86) PCT No.: PCT/EP2024/057738

§ 371 Date: Oct. 10, 2025

(30) Foreign Application Priority Data
Apr. 14, 2023 (DE) 10 2023 203 407.7

(51) Int. Cl. B01J 31/06; B01J 19/24; B01J 23/38; B01J 31/00; B01J 35/39; B01J 35/40

(52) U.S. Cl. CPC B01J 31/06; B01J 19/248; B01J 23/38; B01J 31/003; B01J 35/39; B01J 35/40

(57) ABSTRACT

An arrangement is provided which comprises a polymer-containing layer, a first catalyst and a second catalyst. The two catalysts are suitable for catalysing mutually different chemical reactions. The polymer-containing layer is, at least in parts, transparent to light at least of a particular wavelength in the range from 250 nm to 1000 nm. A throughflow reactor and a method for catalysing at least two reactions are also provided, and uses of the arrangement and of the throughflow reactor are proposed.

An arrangement is provided comprising a polymer-comprising layer, a first catalyst and a second catalyst. The two catalysts are suitable for catalyzing different chemical reactions. The polymer-comprising layer is at least partially transparent to light of at least one specific wavelength in the range from 250 nm to 1000 nm. Further, a flow reactor and a method for catalyzing at least two reactions are provided and uses of the arrangement and the flow reactor are proposed.

Chemical reactions can be accelerated with catalysts (or catalyst materials) and their product selectivity can be significantly improved. As a rule, a particular catalyst can only catalyze one specific chemical reaction (i.e., one reaction step).

In known arrangements from the state of the art, chemical reactions are often carried out in so-called batch processes. This is time-consuming and cost-intensive, as the assemblies must at least be unloaded and cleaned with aqueous or organic solvents (often also vented and cooled) before the assemblies can be used for a further chemical reaction, i.e., there are periods during which the assemblies cannot be used for a desired chemical reaction, i.e., there are periods of time during which the assemblies cannot be used for a desired chemical reaction.

To remedy this, prior art arrangements have been developed that allow a continuous flow of reaction solution over the catalysts (continuous process). For this purpose, at least one of the catalysts used must be immobilized on a surface of the arrangement in order to prevent leaching from the arrangement. For the immobilization of a catalyst on a surface, numerous reactions are described in the literature (e.g., Abdul-Wahab, R. et al., Reactive and Functional Polymers, 152:104613).

Photocatalysis, and in particular the implementation of photocatalyzed syntheses with visible light, has been a very active field of research for around 15 years. The use of micro-process technology (μVT) leads above all to a significantly better light yield and process control. The formation of thin liquid films in microchannels or capillaries enables a complete and uniform irradiation of the reaction solution, which is not possible in a stirred tank. This guarantees a more stable process control and better selectivity to the product, as the reaction solution is irradiated in a targeted manner and not uncontrolled several times, as is usual in the stirred tank.

In known arrangements for photochemical catalysis, the catalysts are usually present in dissolved form or in nanoparticulate form in the reaction solution. This has the disadvantage that the catalysts have to be removed from the reaction solution in a time-consuming and cost-intensive work-up step after the chemical reaction has been carried out so that the reaction solution can be used for a further synthesis step. To solve this problem, photocatalysts have already been immobilized on surfaces while retaining their photophysical and catalytic properties in order to avoid the cleaning step after the chemical reaction. Either inorganic materials (e.g., TiO₂ or SiO₂) or organic materials (polymers, foams or cotton) were used as surfaces for immobilization. However, it has been observed that certain photocatalysts immobilized on these surfaces at a high density can aggregate, changing their absorption properties or causing undesirable quenching effects and thus eliminating the catalytic effect.

Fabry, D. C. et al. (Green Chemistry, vol. 19, pp. 1911-1918) disclose a falling film flow reactor for catalyzing the blue light-mediated C-H arylation of heteroarenes by a TiO₂ photocatalyst. The TiO₂ photocatalyst was immobilized on the front side of a blue light-intransparent layer of stainless steel and blue light was irradiated onto the front side of the layer to cause the photochemical reaction.

The arrangement described by Fabry, D. C. et al. has several disadvantages: Firstly, it is not possible to carry out at least two chemical reactions (e.g., a cascade reaction) with this arrangement, as it only has a single catalyst (TiO₂ photocatalyst). Secondly, with this arrangement it is not possible to carry out the photoreaction by shining the light required for the reaction (in this case blue light) onto the back of the layer, i.e., the side of the layer facing away from the immobilized TiO₂ photocatalyst, as the stainless steel of the layer is not transparent to the light required for this reaction. For photocatalysts with liquids and/or reactants that absorb at a wavelength of the required light, the disadvantage is that the photoreaction cannot be carried out with a high efficiency due to a lower amount of light reaching the photocatalyst. As the amount of light that ultimately reaches the photocatalyst is also unknown in these cases, the reaction cannot be precisely controlled or monitored. In addition, due to the direct exposure of the absorbing liquids and/or reactants to light, it cannot be ruled out that undesirable by-products are formed, the subsequent separation of which from the desired reaction products can be time-consuming and cost-intensive or which can reduce the overall yield of desired products.

Based on this, it was the object of the present invention to provide an arrangement and a process which enable at least two chemical reactions to be carried out with a maximum product yield per time, low time expenditure, low costs, high efficiency, precise controllability and without the risk of undesirable by-products occurring.

The object is solved by the arrangement with the features of claim 1, the flow reactor with the features of claim 15, the method with the features of claim 20 and the use with the features of claim 25. The dependent claims demonstrate advantageous developments.

According to the invention, an arrangement for catalysis of at least two (chemical) reactions is disclosed, comprising or consisting of:
a) a layer having a front side and a rear side, the layer comprising or consisting of a polymer;
b) a first catalyst suitable for catalyzing a first reaction and immobilized on the front surface of the layer; and
c) a second catalyst suitable for catalyzing a second reaction which is different from the first reaction;
   characterized in that the layer is at least partially transparent to light of at least one specific wavelength in the range from 250 nm to 1000 nm (optionally, the layer is transparent to light of all wavelengths in this range).

The arrangement according to the invention has the advantage that it can be used to carry out at least two chemical reactions with a maximum product yield per time, low time expenditure, low costs, high efficiency, precise controllability and without the risk of undesirable by-products occurring. The reason for this is that the arrangement comprises a second catalyst.

A further advantage results from the fact that the layer on the front side of which the first catalyst is immobilized is a layer that is transparent to light of at least a specific wavelength in the range from 250 nm to 1000 nm. This allows the irradiation of light on the back of the layer, so that the first catalyst immobilized on the front of the layer and also the second catalyst can be exposed to a maximum and defined amount of light and a disturbing influence on the amount of light caused by the reaction liquid and/or reactants can be minimized. This is particularly advantageous if the first catalyst and/or second catalyst is a photocatalyst, since in this case the maximum product yield per time and the efficiency of the photochemical reaction is higher and the photochemical reaction can be controlled more precisely and can be carried out without risk of the occurrence of undesirable by-products.

As the layer comprises or consists of a polymer, there is the additional advantage that the arrangement can be provided at a lower cost than an arrangement comprising a layer of stainless steel. Furthermore, an advantage over arrangements comprising a layer of glass is that the arrangement is more resistant to mechanical stresses and the orientation of the layer can be flexibly changed, i.e., the layer can, for example, be brought into a geometric arrangement that deviates from the geometric arrangement of the original layer (e.g., from flat to curved, wavy or similar) as required.

The light of the specific wavelength to which the layer is at least partially transparent is preferably light of a wavelength required to catalyze the first and/or second reaction (e.g., if the first and/or second reaction is/are a photochemical reaction catalyzed by a photocatalyst as first and/or second catalyst).

The layer of the arrangement according to the invention can be transparent to light of at least one specific wavelength in the range from 300 to 800 nm, at least in certain regions (optionally, the layer is transparent to light of all wavelengths in this range). The light of the specific wavelength is preferably light of a wavelength that is required for catalysis of the first and/or second reaction.

Furthermore, the layer can have a layer thickness, in a direction from the front to the back of the layer, in the range from 1 μm to 1500 μm, preferably 2 to 1000 μm, particularly preferably 5 to 500 μm, especially 10 to 200 μm. Lower layer thicknesses have the advantage that the absorption of light is lower, so that when light is irradiated on the back of the layer, a higher amount of light reaches the upper side of the layer, on which at least the first catalyst is immobilized.

Furthermore, the layer on the front and/or back may be planar or non-planar. In the case of a non-planar layer, the front side and/or back side of the layer (in particular the front side of the layer) optionally has a structuring, which is preferably selected from the group consisting of wave-shaped structuring, channel-shaped structuring and combinations thereof. The channel-shaped structuring may comprise a plurality of parallel microchannels (e.g., ≥10, preferably ≥20, particularly preferably ≥30, parallel microchannels), wherein the microchannels each preferably have a width (i.e., an extension parallel to the surface of the layer and perpendicular to its direction of travel) in the range from 100 to 1000 μm (preferably 200 to 800 μm) and/or each preferably having a depth (i.e., an extension perpendicular to the surface of the layer) in the range from 50 to 500 μm (preferably 100 to 300 μm). The channel-shaped structure in the form of a large number of microchannels has the advantage that the reaction volume is kept very low and thus allows efficient mixing of a reactive gas (e.g., O₂) with the reaction liquid and thus with the catalysts and the at least one reactant. This means that the reactive gas can be used up much more quickly and, in the event of a leak, large quantities of hazardous gas can be prevented from being released. There is also an advantage in terms of the selectivity of the reaction to be catalyzed, as a chemical process can be controlled much better in a small reaction volume than in a larger reaction volume.

The layer can be designed as a film, preferably a rigid or flexible film.

In a preferred embodiment, the layer has a transmittance of ≥50%, preferably ≥70%, particularly preferably ≥90%, especially ≥95%, optionally ≥99%, for light of at least a specific wavelength in the range from 250 nm to 1000 nm, preferably in the range from 300 to 800 nm, optionally in the range from 320 to 800 nm (optionally the layer has such a transmittance for light of all wavelengths in this range). The light of the specific wavelength is preferably light of a wavelength that is required for catalysis of the first and/or second reaction. The higher the transparency of the coating, the higher the proportion of irradiated light that reaches the front of the coating and therefore the first catalytic converter (and also the second catalytic converter) after passing through the coating.

The polymer of the layer may be selected from the group consisting of polyolefin, polyester, polyamide, polyetherimide, polylactide, PEN, PVC, EVA, cellulose derivatives and combinations and copolymers thereof.

Furthermore, the polymer of the layer may have at least one functional group on the surface of the layer. The advantage here is that the first catalyst (optionally also the second catalyst) can be covalently immobilized on the front side of the layer (optionally also on the back side of the layer), which prevents the catalysts from being washed out and thus increases the product purity and makes the arrangement more stable over the long term.

The at least one functional group is preferably selected from the group consisting of hydroxy group, amino group, azide group, thiol group, aldehyde group, alkyne group, alkene group, carboxylic acid group, carboxylic anhydride group, epoxy group, sulfonic acid group, sulfonic acid chloride group, trinitriloacetic acid group and combinations thereof. Optionally, the functional group (preferably in the case of a trinitriloacetic acid group) is complexed with at least one metal ion, wherein the at least one metal ion is preferably selected from the group consisting of Ni ion, Co ion, Zn ion and combinations thereof.

The polymer of the layer may be functionalized at the surface of the layer via a process selected from the group consisting of liquid treatment processes, gas phase processes, plasma processes, and combinations thereof, wherein the liquid treatment process is preferably selected from the group consisting of dipping, printing, spraying, doctoring, grafting, and combinations thereof. In other words, at least one functional group can be generated on the surface of the layer using at least one of these methods.

The first catalyst may be selected from the group consisting of photocatalyst, noble metal catalyst, enzymatic catalyst and organic, non-enzymatic catalyst. Preferably, the first catalyst is a photocatalyst. Since the first catalyst is immobilized on the front side of the layer, the advantage in the case of a photocatalyst is that the first catalyst can be exposed to the maximum possible amount of light when light is irradiated onto the back side of the layer.

The first catalyst can be a non-particulate catalyst or a particulate catalyst.

In a preferred embodiment, the first catalyst catalyzes a conversion of a starting material, which is a product of a catalysis of the second catalyst, to a product. In other words, in this case the first catalyst catalyzes a second stage of a cascade reaction, the first stage of which is catalyzed by the second catalyst.

The first catalyst can be immobilized on the surface of the layer via at least one non-covalent bond. The advantage here is that the immobilization of the first catalyst on the front side of the layer can also be realized without functionalization of the front side of the layer, which can make the provision of the arrangement more cost-effective. The at least one non-covalent bond is preferably selected from the group consisting of hydrogen bonding, dipole-dipole interaction, n-n-interaction, van der Waals interaction, ionic interaction, hydrophobic interaction and combinations thereof.

Furthermore, the first catalyst can be immobilized on the surface of the layer via at least one covalent bond. The advantage here is that the immobilization and thus the arrangement is stable over the long term and detachment of the first catalyst from the layer can be prevented, thus avoiding contamination of the product with the first catalyst. The covalent bond is preferably established by a functional group selected from the group consisting of ketone, ester, carbamate, carbonate, ether, amide, urethane, disulfide, sulfonamide, sulfonic acid ester, thioether, triazole and combinations thereof.

Furthermore, the first catalyst can be immobilized on the surface of the layer via a spacer. This has the advantage that a possible disturbing influence of the surface of the layer on the activity of the catalyst is avoided and the catalyst, despite its immobilization, has more degrees of freedom on the surface of the substrate, which can improve its catalytic efficiency. The spacer is preferably selected from the group consisting of n-alkane, heterocycle, oligomer, polymer, plasma polymer, and combinations thereof, wherein the spacer is particularly preferably selected from the group consisting of polyetherimine, polyethylene glycol, functionalized polysaccharide, polyacrylic acid-like plasma polymer, and combinations thereof.

In addition, the first catalyst may be immobilized on the surface of the layer by a wet chemical process, wherein the wet chemical process is preferably selected from the group consisting of immersion processes, liquid pressure processes and combinations thereof. The liquid pressure process has the advantage that the catalyst can be immobilized very selectively (i.e., with high spatial resolution) on the surface of the substrate.

The first catalyst can be immobilized evenly distributed on the surface of the layer (i.e., isotropically immobilized in all spatial directions of the surface). This has the advantage that the same catalysis conditions are provided over the entire surface of the substrate in relation to the first catalyst. Preferably, the second catalyst is also evenly distributed on the surface of the layer and immobilized at a certain distance from the first catalyst. This has the advantage that the same catalysis conditions are provided on the entire surface of the substrate with regard to both catalysts and a cascade reaction can proceed efficiently. The determined distance from the first catalyst to the second catalyst is preferably in a range from 1 nm to 1000 μm, optionally in a range from 200 nm to 1000 μm, wherein the distance refers to a distance determined by confocal Raman microscopy or electron microscopy. The person skilled in the art will select a suitable determination method (e.g., confocal Raman microscopy for organic catalysts and electron microscopy for inorganic catalysts). The smaller the distance, the higher the efficiency of the catalysis. However, the distance should not be too small to prevent the activity of the first catalytic converter from being negatively affected by the second catalytic converter and vice versa.

Furthermore, the first catalyst may be immobilized in a first region of the surface of the layer and the second catalyst may be immobilized in a second region of the arrangement which is different from the first region of the surface of the layer and which has a distance from the first region of the surface of the layer which is in the range from 1 μm to 20 cm, preferably 10 μm to 10 cm. This arrangement has the advantage that the reactions of the first catalyst and the second catalyst take place in spatially separated areas on the layer, which can avoid undesirable side reactions in the event of a lower reactivity of at least one of the two catalysts. Furthermore, in the case of a cascade reaction, it is thus possible to give the reaction a direction, i.e., for example, to allow the liquid comprising the educt to first flow over the first region (comprising the first catalyst) and then to allow the liquid (comprising the product of the catalysis of the first catalyst and the educt for the catalysis reaction with the second catalyst) to flow over the second region. This measure can prevent possible side reactions and provide a product of higher purity. The second area can be a second area on the surface of the layer of the arrangement or an area on a surface of another layer of the arrangement. The further layer of the arrangement can have at least one feature (optionally all features) that the layer of the arrangement also has.

The second catalyst may be selected from the group consisting of photocatalyst, noble metal catalyst, enzymatic catalyst and organic, non-enzymatic catalyst, wherein the second catalyst is preferably an enzymatic catalyst.

Furthermore, the second catalyst can be a non-particulate catalyst or a particulate catalyst.

In addition, the second catalyst can catalyze a conversion of a reactant, which is a product of a catalysis of the first catalyst, to a product. In this case, the second catalyst catalyzes a second stage of a cascade reaction, the first stage of which is catalyzed by the first catalyst.

Furthermore, the second catalyst (like the first catalyst) can be immobilized on the front side of the layer. Firstly, immobilizing the second catalyst has the advantage that the second catalyst does not have to be part of the reaction liquid and therefore does not have to be removed from the product stream in a time-consuming and cost-intensive process. Furthermore, there is an advantage if the second catalyst tends to aggregate in the reaction liquid, thereby reducing its activity (which may be the case with certain enzymatic catalysts, for example), because in this case the immobilization of the second catalyst can prevent aggregation and thus a reduction in the activity of the second catalyst. There is also an advantage in the case of a photocatalyst as a second catalyst: The immobilization on the front of the layer means that the second catalyst can experience a maximum and defined amount of light when light is shone onto the back of the layer. In the case of a second catalyst flowing in the reaction medium, this is not always the case.

The second catalyst can be immobilized on the surface of the layer via at least one non-covalent bond. The at least one non-covalent bond is preferably selected from the group consisting of hydrogen bonding, dipole-dipole interaction, π-π-interaction, van der Waals interaction, ionic interaction, hydrophobic interaction and combinations thereof.

Furthermore, the second catalyst can be immobilized on the surface of the layer via at least one covalent bond. The covalent bond is preferably established by a functional group selected from the group consisting of ketone, ester, carbamate, carbonate, ether, amide, sulfide, disulfide, and combinations thereof.

In addition, the second catalyst can be immobilized on the surface of the layer via a spacer. The spacer is preferably selected from the group consisting of n-alkane, heterocycle, oligomer, polymer, plasma polymer and combinations thereof. Particularly preferred is the spacer selected from the group consisting of polyetherimine, polyethylene glycol, functionalized polysaccharide, polyacrylic acid-like plasma polymer and combinations thereof.

In addition, the second catalyst can be immobilized on the surface of the layer using a wet chemical process. The wet chemical process is preferably selected from the group consisting of immersion processes, liquid pressure processes and combinations thereof.

In addition, the second catalyst can be immobilized on the surface of the layer and/or on a surface of a further layer of the arrangement. The further layer of the arrangement can have at least one feature (optionally all features) that the layer of the arrangement also has.

Preferably, the second catalyst is immobilized evenly distributed on the surface of the layer at a certain distance from the first catalyst. The determined distance from the first catalyst to the second catalyst is preferably in a range from 1 nm to 1000 μm, optionally in a range from 200 nm to 1000 μm, wherein the distance refers to a distance determined by confocal Raman microscopy or electron microscopy. The person skilled in the art will select a suitable determination method (e.g., confocal Raman microscopy for organic catalysts and electron microscopy for inorganic catalysts).

Furthermore, the second catalyst may be immobilized in a second region of the surface of the layer and the first catalyst may be immobilized in a first region of the surface of the layer which is different from the first region of the surface of the layer and which has a distance from the first region of the surface of the layer which is in the range from 1 μm to 20 cm, preferably 10 μm to 10 cm.

Moreover, the second catalyst may be immobilized in a region of a surface of a further layer of the arrangement and the first catalyst may be immobilized on the surface of the layer, wherein the region of the surface of the further layer of the arrangement has a distance from the region of the surface of the layer of the arrangement which is in the range from 1 μm to 20 cm, preferably 10 μm to 10 cm. The further layer of the arrangement can have at least one feature (optionally all features) that the layer of the arrangement also has.

The first catalyst and/or the second catalyst may be a particulate catalyst. It is possible that the particulate catalyst comprises the first catalyst and not the second catalyst, comprises the second catalyst and not the first catalyst, or comprises the first and second catalyst.

Furthermore, the first catalyst and/or the second catalyst may be a supraparticulate catalyst. It is possible that the supraparticulate catalyst comprises the first catalyst and not the second catalyst, comprises the second catalyst and not the first catalyst, or comprises the first and second catalyst.

Furthermore, the supraparticulate catalyst can have a diameter in the range from 1 μm to 20 μm, preferably in the range from 1 μm to 10 μm.

Furthermore, the supraparticulate catalyst can comprise or consist of a large number of catalytically active nanoparticles. The nanoparticles preferably have a diameter in the range from 1 nm to 500 nm, particularly preferably 5 nm to 150 nm, very particularly preferably 5 nm to 100 nm.

In addition, the supraparticulate catalyst may comprise or consist of a plurality of catalytically inactive carrier particles whose surface is coated with catalytic particles comprising or consisting of catalytically active molecules, ions and/or atoms. Preferably, the carrier particles have a diameter in the range from 1 nm to 500 nm, particularly preferably 5 nm to 150 nm, most preferably 5 nm to 100 nm. The catalytic particles preferably have a diameter in the range from 1 μm to 20 μm, preferably 1 μm to 10 μm.

Furthermore, the supraparticulate catalyst may comprise or consist of a plurality of catalytically active nanoparticles and catalytically inactive carrier particles, the surface of which is coated with catalytic particles of catalytically active molecules, ions and/or atoms. The properties of the catalytically active nanoparticles and/or the catalytically inactive carrier particles can correspond to the above-mentioned properties of these particles.

The supraparticulate catalyst may be prepared by spray-drying, preferably by spray-drying at least one dispersion comprising catalytically active nanoparticles and/or at least one dispersion comprising catalytically inactive carrier particles and comprising catalytic particles comprising or consisting of catalytically active molecules, ions and/or atoms. During spray drying, the individual nanoparticles in the sprayed liquid droplets accumulate by forced self-assembly to form densely packed, complex, supramolecular structures and thus determine the properties of the supraparticles. Spray drying can be used to produce supraparticulate catalysts on a ton scale.

The arrangement can have a liquid that contacts the front of the layer.

The liquid preferably comprises water. This has the advantage that certain catalysts (e.g., enzymes) have a high catalytic efficiency or do not suffer a loss of their catalytic efficiency (e.g., due to denaturation in the case of an enzyme).

The liquid may also comprise oxygen. Oxygen plays a role in a variety of photochemical reactions, for example the presence of oxygen in the liquid enables photochemical generation of ¹O₂ in situ, i.e., if the first and/or second catalyst is a photocatalyst, at the location of the photocatalyst or photocatalysts of the arrangement, whereby the ¹O₂ generated in situ is in turn available for a subsequent reaction with a reactant of the liquid.

In addition, the liquid may comprise a nucleophilic reagent, preferably a cyanide salt, particularly preferably NaCN. The advantage here is that a nucleophilic addition to a specific reactant can be catalyzed by a catalyst in the arrangement.

Furthermore, the liquid may comprise a halogenating agent, preferably a halogenating agent comprising fluorine as electrophile or nucleophile. This enables catalysis of a halogenation reaction by the arrangement according to the invention.

In addition, the liquid may comprise at least one organic solvent, preferably selected from the group consisting of alcohol, DMSO and mixtures thereof. This has the advantage that reactants with a high hydrophobicity can be dissolved in the liquid in high concentrations, which increases the efficiency of the catalytic reactions. The alcohol is preferably a C₁-C₆ alcohol. In particular, the alcohol is selected from the group consisting of methanol, ethanol, 2-propanol and mixtures thereof. These alcohols have the advantage that they dissolve hydrophobic organic substances well and have a relatively low viscosity under normal conditions (25° C.), which leads to better wetting of the surface of the layer of the device and better thin film formation on the surface of the layer of the device, so that light transmission and gas mass transfer become more efficient.

In a preferred embodiment, the liquid comprises at least one reactant, optionally several reactants, the conversion of which to a product is catalyzed by the first and/or second catalyst. If the first and/or second catalyst catalyzes a photochemical reaction, this has the advantage that only light needs to be irradiated onto the catalysts of the arrangement in order to convert the at least one reactant or the multiple reactants into at least one product. In other words, this shortens the time required to manufacture the product. The at least one reactant is preferably selected from the group consisting of, β-keto-carboxylic acid and alkylated benzene.

The liquid may comprise the second catalyst. This embodiment describes an arrangement in which the second catalyst is not immobilized on (the front side of) the layer of the arrangement. This embodiment can be advantageous if the second catalyst is not a photocatalyst, the first catalyst is a photocatalyst and a maximum occupancy density of the first catalyst (photocatalyst) on the front side of the layer of the arrangement is desired in order to enable maximum light capture of the first catalyst in the event of irradiation of the layer on the rear side of the layer and thus to achieve maximum efficiency of the photochemical reaction.

Further, the liquid may be disposed at a height on the front surface of the layer (“film thickness”) which is in the range of 10 to 200 μm, preferably 20 to 100 μm, wherein the height corresponds to a length from a lowest point of the front surface of the layer to a point of the liquid which is furthest from the lowest point of the front surface of the layer. The arrangement may comprise a support frame adapted to support the layer in a reversible manner, the layer preferably being supported by the support frame.

In a preferred embodiment, the arrangement comprises a light source which is configured to emit light of at least one specific wavelength in the range from 250 nm to 1000 nm, preferably in the range from 300 nm to 800 nm, optionally in the range from 320 nm to 800 nm, in the direction of the front side and/or rear side of the layer, and optionally in the direction of the front side and/or rear side of at least one further layer of the arrangement (optionally the light source is configured to emit light in the entire specified wavelength range). The light of the specific wavelength is preferably light of a wavelength that is required for catalysis of the first and/or second reaction. Preferably, the light source is configured to radiate in the direction of the rear side of the layer and/or the at least one further layer. The further layer of the arrangement can have at least one feature (optionally all features) that the layer of the arrangement also has. The configuration of the light source to emit light to the back of the layer has the advantages that in the case of reaction liquids, reactants and/or products that absorb in the wavelength range of the light source, at least two reactions can be carried out with greater efficiency, more precise controllability and without the risk of unwanted by-products occurring.

According to the invention, there is further provided a flow reactor comprising
a) an arrangement according to the invention;
b) an inlet for a liquid; and
c) an outlet for a liquid;
   wherein the inlet and outlet are each fluidically connected at least to the front side of the layer.

With the flow reactor according to the invention, it is possible to carry out at least two chemical reactions with a maximum product yield per time, low time expenditure, low costs, high efficiency, precise controllability and without risk of the occurrence of undesirable by-products. Through the inlets and outlets for liquid, the at least two chemical reactions can be carried out in a continuous manner, which-in contrast to batch reactions-allows continuous production of industrially relevant quantities of products. Furthermore, the cleaning steps required in batch processes can be omitted, which results in a time and cost advantage.

In the flow reactor, the first catalyst may be immobilized in a first region of the surface of the layer which faces the inlet and the second catalyst may be immobilized in a region of the arrangement which faces the outlet and which does not overlap with the first region of the surface of the layer. This arrangement has the advantage that a sequential reaction (cascade reaction) of a specific reactant can be carried out without causing undesirable side reactions or a decrease in reaction efficiency.

The inlet for a liquid of the flow reactor can be connected to a liquid source containing a liquid.

The liquid of the liquid source preferably comprises water.

Furthermore, the liquid of the liquid source may comprise a nucleophilic reagent, preferably a cyanide salt, particularly preferably NaCN.

In addition, the liquid of the liquid source may comprise a halogenating agent, preferably a halogenating agent comprising fluorine as electrophile or nucleophile.

In addition, the liquid of the liquid source may comprise at least one organic solvent. The organic solvent is preferably a C₁-C₆ alcohol. Particularly preferred is the organic solvent selected from the group consisting of methanol, ethanol, 2-propanol and mixtures thereof.

In a preferred embodiment, the liquid of the liquid source comprises at least one reactant, optionally several reactants, the conversion of which to a product is catalyzed by the first and/or second catalyst. The at least one reactant is preferably selected from the group consisting of β-keto-carboxylic acid and alkylated benzene.

Furthermore, the liquid of the liquid source can comprise the second catalyst.

The flow reactor may be configured to direct the liquid of the liquid source across the front surface of the layer of the assembly such that the liquid flows across the front surface of the layer at a height ranging from 10 to 200 μm, preferably 20 to 100 μm, the height corresponding to a length from a lowest point of the front of the layer to a point of the liquid furthest from the lowest point of the front of the layer. This configuration can be achieved by structuring the arrangement of the flow reactor and/or by a suitable transport quantity of liquid per time across the front of the layer of the arrangement.

The flow reactor can have an inlet for a gas and an outlet for a gas. This embodiment is advantageous if one of the at least two reactions catalyzed by the flow reactor is a reaction in which a gas (e.g., oxygen) is required.

The inlet for a gas and the outlet for a gas can each be fluidically connected at least to the front of the layer.

Furthermore, the inlet for a gas is preferably connected to a gas source, which in particular contains oxygen. Oxygen plays an important role in a variety of photochemical reactions in order to generate a certain product, i.e., this embodiment is particularly advantageous if the first and/or second catalyst is a photocatalyst.

The flow reactor can have at least two, preferably at least three, particularly preferably at least four, especially at least five, arrangements according to the invention. The arrangements can be connected fluidically in parallel or fluidically in series in a direction from the inlet to the outlet of the flow reactor. The parallel circuit has the advantage that at least two reactions per arrangement can be catalyzed in parallel, thus increasing the product yield per time. A serial circuit has the advantage that a more than two-stage cascade reaction from a reactant to a specific product is possible. In the case of a serial circuit, the output of an arrangement located upstream can be fluidically connected to the input of another arrangement located directly downstream of the arrangement.

Between the respective arrangements, the first and/or second catalysts may be the same or different.

The flow reactor can be a falling film flow reactor.

According to the invention, there is also provided a method for catalyzing at least two (chemical) reactions, comprising or consisting of the following steps:
a) providing an arrangement according to the invention or a flow reactor according to the invention; and
b) contacting at least the first surface of the layer with a liquid, wherein the liquid comprises at least one reactant whose conversion to a product is catalyzed by the first and second catalysts, or
   the liquid comprises at least one first reactant, the conversion of which to at least one first product is catalyzed by the first or second catalyst, and the liquid comprises at least one second reactant, the conversion of which to at least one second product is catalyzed by one of the first or second catalysts which does not catalyze the conversion of the first reactant to a first product.

With the method according to the invention, it is possible to carry out at least two chemical reactions with a maximum product yield per time, low time expenditure, low costs, high efficiency, precise controllability and without risk of the occurrence of undesirable by-products.

In a preferred embodiment of the method, light of at least one specific wavelength in the range from 250 nm to 1000 nm, preferably in the range from 300 nm to 800 nm, optionally in the range from 320 nm to 800 nm, is irradiated in the direction of the front side and/or rear side of the layer, and optionally in the direction of the front side and/or rear side of at least one further layer of the arrangement. The light of the specific wavelength is preferably light of a wavelength that is required for catalysis of the first and/or second reaction. Preferably, the light is emitted in the direction of the rear side of the layer and/or the rear side of the at least one further layer of the arrangement.

In step a) of the method, a flow reactor can be provided and the liquid can be directed (or transported) from the inlet to the outlet of the flow reactor. Particularly preferably, the liquid is first passed over the first catalyst, which is immobilized in a first region of the surface of the layer facing the inlet, and the liquid is then passed over the second catalyst, which is immobilized in a region of the arrangement facing the outlet and which does not overlap with the first region of the layer of the arrangement.

The flow reactor provided (and used) in the method may further comprise at least one inlet for a gas and at least one outlet for a gas. Preferably, the inlet for the gas and the outlet for the gas are each fluidically connected to the front side of the layer and/or to a front side of a further layer of the arrangement, the gas being transported from the inlet for a gas to the outlet for a gas.

The flow reactor provided (and used) in the method can have at least two, preferably at least three, particularly preferably at least four, in particular at least five, arrangements according to the invention. Preferably, the arrangements are fluidically connected in parallel or in series in one direction from the inlet to the outlet of the flow reactor. It is particularly preferred that the liquid is transported fluidically in parallel or in series from the inlet for one liquid to the outlet for one liquid. Optionally, a gas is (also) transported fluidically in parallel or in series from an inlet for a gas of the flow reactor to an outlet for a gas of the flow reactor.

Between the respective arrangements of the flow reactor provided (and used) in the method, the first and/or second catalysts may be the same or different.

According to the invention, use of the arrangement according to the invention or of the flow reactor according to the invention for catalysis of at least two reactions, preferably of at least two interdependent reactions taking place in a cascade or of two independent reactions, is also proposed.

The object according to the invention will be explained in more detail with the aid of the following figures, without wishing to restrict it to the specific embodiments shown here.

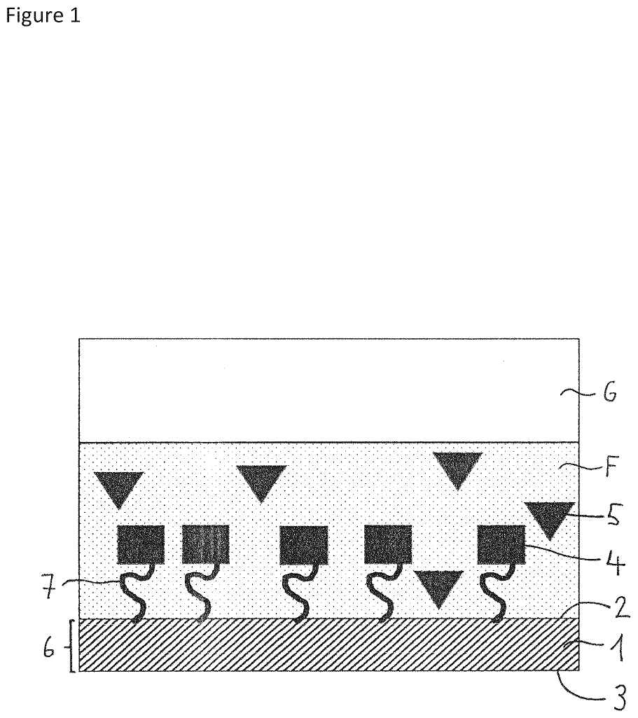

FIG. 1 schematically shows an arrangement according to the invention for the catalysis of at least two reactions. The arrangement has a layer 1 with a front side 2 and a rear side 3, wherein the layer 1 comprises or consists of a polymer. Furthermore, the arrangement has a first catalyst 4 which is suitable for catalysing a first reaction and which is immobilized on the front side 2 of the layer 1. In addition, the arrangement has a second catalyst 5 which is suitable for catalyzing a second reaction which is different from the first reaction. In the embodiment shown here, the first catalyst 4 is a photocatalyst and the second catalyst 5 is an enzyme. The arrangement is characterized in that the layer 1 is transparent, at least in some areas, to light of a wavelength in the range from 250 nm to 1000 nm. Layer 1 here has a layer thickness 6 of 100 μm. In the embodiment shown, the first catalyst 4 is immobilized on the front side 2 of the layer 1 via a spacer 7 and the second catalyst 5 is freely movable in the liquid F on the front side 2 of the layer 1. Gas G is arranged above the liquid F (e.g., air or pure oxygen), which can dissolve in the liquid F and may be necessary for the reaction which is accelerated by the first catalyst 4 and/or by the second catalyst 5 (e.g., photochemical generation of singlet oxygen from oxygen).

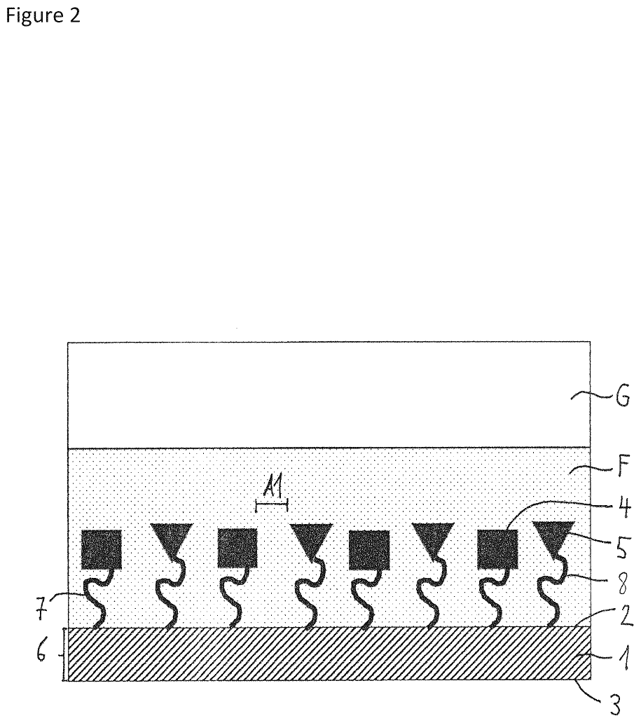

FIG. 2 schematically shows another arrangement according to the invention. One difference to the arrangement in FIG. 1 is that here the second catalyst 5 is also immobilized on the front side 2 of the layer 1 via a spacer 8. This creates a certain distance A1 between the first catalyst 4 and the second catalyst 5 on the front side 2 of the layer 1. The specific distance A1 establishes a spatial separation between the first catalyst 4 and the second catalyst 5. This prevents the two catalysts 4 and 5 from interfering with each other's function.

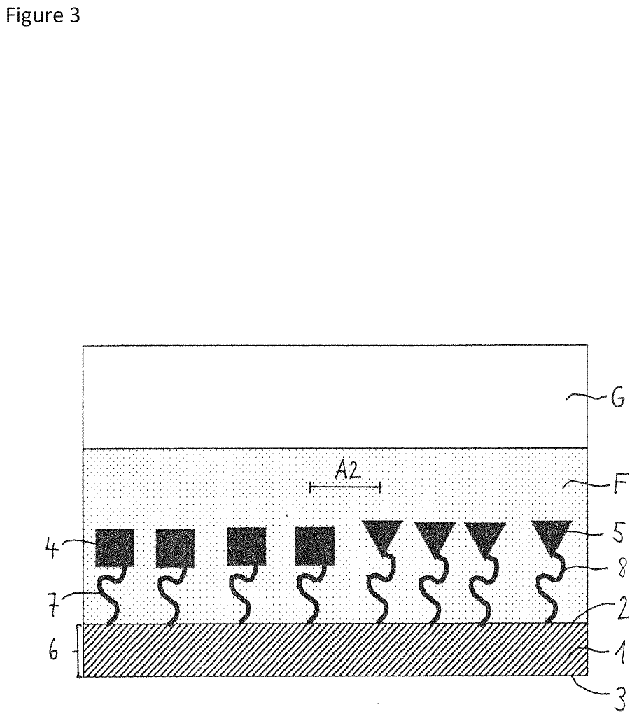

FIG. 3 schematically shows another arrangement according to the invention. A difference to the arrangement of FIG. 2 is that the first catalyst 4 is immobilized in a first region of the surface of the layer 1 and the second catalyst 5 is immobilized in a second region of the surface of the layer 1, wherein there is a certain distance A2 from the first region of the surface of the layer to the second region of the surface of the layer. The specific distance A2 establishes an even greater spatial separation between the first catalyst 4 and the second catalyst 5 than in the arrangement shown in FIG. 2. Due to this spatial separation, a direction can be imposed on a cascade reaction, i.e., liquid F (and optionally gas G) can first be passed over the first catalyst 4 and generate a first product and only then be passed over the second catalyst 5 to convert the first product into a final product. This can prevent the end product from reacting with the first catalyst 4 in an undesirable way and creating unwanted by-products.

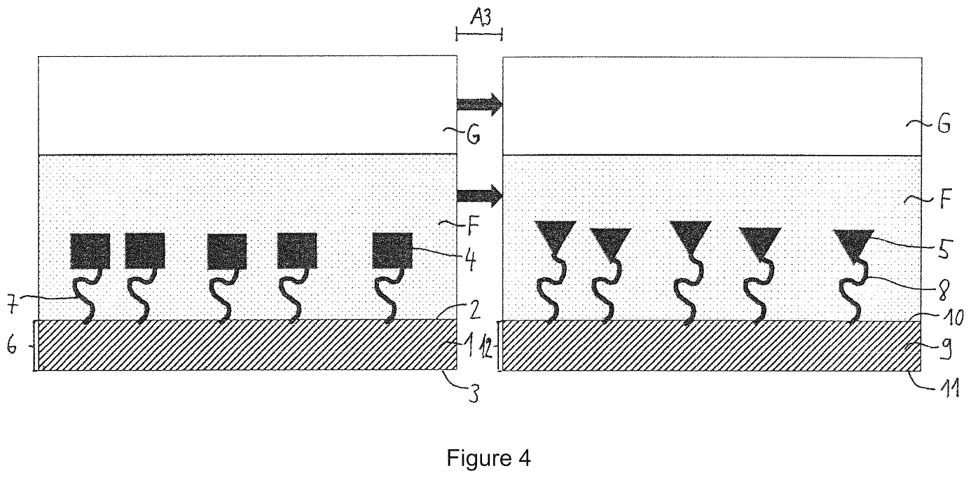

FIG. 4 schematically shows another arrangement according to the invention. A difference to the arrangement of FIG. 3 is that the first catalyst 4 is immobilized on the surface of the layer 1 and the second catalyst 5 is immobilized on the front side 10 and the surface of a further layer 9, there is a certain distance A3 from the region of the surface of the further layer to the region of the surface of the layer. The front side 2 of layer 1 is fluidically connected to the front side 10 of the further layer 9, i.e., liquid F and gas G can flow from the front side 2 of layer 1 to the front side 10 of the further layer 9. Due to the specific distance A3, a spatial separation can be established between the first catalyst 4 and the second catalyst 5, which is independent of the dimensions of the layer 1 and can therefore also be designed to be very high, which can ensure the formation of undesirable by-products even better. This design also offers a high degree of flexibility: Since each of the layers 1, 9 carries only one specific catalyst 4, 5, each of the layers 1, 9 catalyzes only one specific reaction. If there is now a desire to produce a different product via a cascade reaction, for example, the other layer 9 of the arrangement can be quickly and easily replaced by another layer 9 that carries a different second catalyst 5.

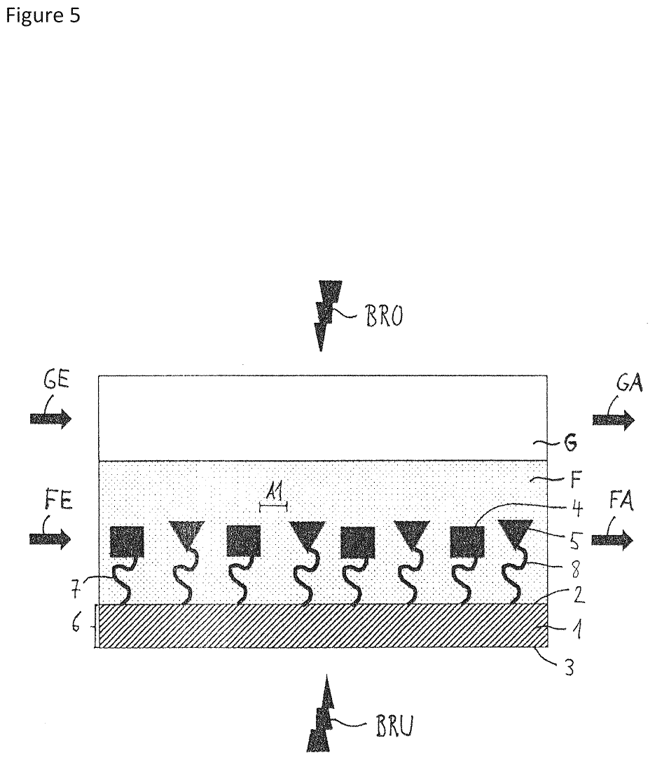

FIG. 5 schematically shows a flow reactor according to the invention. The flow reactor here has an arrangement as shown in FIG. 1. Furthermore, the flow reactor has a liquid inlet FE and a liquid outlet FA for conducting the liquid F via the front side 2 of the layer 1, the liquid inlet FE and the liquid outlet FA each being fluidically connected to the front side 2 of the layer 1. In addition, the flow reactor has a gas inlet GE and a gas outlet GE for conducting the gas G via the front side 2 of the layer 1, the gas inlet GE and the gas outlet GA each being fluidically connected to the front side 2 of the layer 1. In addition, the flow reactor has at least one light source (not shown) which emits light in an irradiation direction BRU onto the rear side of the layer of the arrangement and, in the case shown, also emits light in an irradiation direction BRO onto the front side of the layer of the arrangement. Preferably, the light source emits light at least onto the rear side 3 of the layer 1 of the arrangement. If the liquid F, the gas G, a reactant and/or a product attenuates the light irradiated by the light source, it is particularly preferable if the light source shines exclusively on the rear side 3 of the layer 1 of the arrangement, as the catalysis by the photocatalyst can then be carried out with a higher efficiency and more precise controllability without the risk of undesired by-products occurring.

### LIST OF REFERENCE NUMERALS

1: layer of the arrangement;
2: front side of the layer of the arrangement;
3: rear side of the layer of the arrangement;
4: first catalyst (e.g., photocatalyst);
5: second catalyst (e.g., enzyme);
6: layer thickness of the layer of the arrangement;
7: spacer on first catalyst;
8: spacer on second catalyst;
9: further layer of the arrangement;
10: front side of the next layer of the arrangement;
11: rear side of the next layer of the arrangement;
12: layer thickness of the next layer of the arrangement;
F: liquid (reaction solution);
G: gas;
A1: distance from the first catalyst to the second catalyst;
A2: distance from the first region of the surface of the layer to the second region of the surface of the layer;
A3: distance from the region of the surface of the further layer to the region of the surface of the layer;
FE: liquid inlet of the flow reactor;
FA: liquid outlet of the flow reactor;
GE: gas inlet of the flow reactor;
GA: gas outlet of the flow reactor;
BRU: irradiation direction on the rear side of the layer of the arrangement;
BRO: irradiation direction on the front side of the layer of the arrangement.

1-25. (canceled)

26. An arrangement for the catalysis of at least two reactions, comprising:
a) a layer having a front side and a rear side, the layer comprising a polymer,
b) a first catalyst suitable for catalyzing a first reaction and immobilized on the front side of the layer, and
c) a second catalyst suitable for catalyzing a second reaction which is different from the first reaction;
wherein the layer is at least partially transparent to light of at least one specific wavelength in the range from 250 nm to 1000 nm.

27. The arrangement according to claim 26, wherein the layer
i) is at least partially transparent to light of at least one specific wavelength in the range from 300 to 800 nm; and/or
ii) has a layer thickness, in a direction from the front side to the rear side of the layer, in the range from 1 μm to 1500 μm; and/or
iii) is planar or non-planar on the front side and/or on the rear side, wherein the front side and/or rear side optionally has a structuring; and/or
iv) is designed as a film; and/or
v) has a transmittance of ≥50% for a light of a wavelength which is required for catalysis of the first and/or second reaction.

28. The arrangement according to claim 26, wherein the polymer of the layer
i) is selected from the group consisting of polyolefin, polyester, poly amide, polyetherimide, polylactide, PEN, PVC, EVA, cellulose derivatives, and combinations and copolymers thereof; and/or
ii) has at least one functional group on the surface of the layer, wherein the at least one functional group is selected from the group consisting of hydroxy group, amino group, azide group, thiol group, aldehyde group, alkyne group, alkene group, carboxylic acid group, carboxylic anhydride group, epoxy group, sulfonic acid group, sulfonic acid chloride group, and trinitriloacetic acid group, wherein the functional group is optionally complexed with at least one metal ion, wherein the at least one metal ion is selected from the group consisting of Ni ion, Co ion, and Zn ion; and/or
iii) is functionalized at the surface of the layer via a process selected from the group consisting of liquid treatment process, gas phase processes, plasma process, and combinations thereof, wherein the liquid treatment process is selected from the group consisting of dipping, printing, spraying, doctoring, grafting, and combinations thereof.

29. The arrangement according to claim 26, wherein the first catalyst
i) is selected from the group consisting of photocatalyst, noble metal catalyst, enzymatic catalyst and organic, and non-enzymatic catalyst; and/or
ii) is a non-particulate catalyst or is a particulate catalyst; and/or
iii) catalyzes a conversion of a reactant, which is a product of a catalysis of the second catalyst, to a product.

30. The arrangement according to claim 26, wherein the first catalyst
i) is immobilized on the surface of the layer via at least one non-covalent bond, wherein the at least one non-covalent bond is selected from the group consisting of hydrogen bonding, dipole-dipole interaction, π-π-interaction, van der Waals interaction, ionic interaction, hydrophobic interaction, and combinations thereof; and/or
ii) is immobilized on the surface of the layer via at least one covalent bond, wherein the covalent bond is established by a functional group selected from the group consisting of ketone, ester, carbamate, carbonate, ether, amide, urethane, disulfide, sulfonamide, sulfonic acid ester, thioether, triazole, and combinations thereof; and/or
iii) is immobilized on the surface of the layer via a spacer, wherein the spacer is selected from the group consisting of n-alkane, heterocycle, oligomer, polymer, plasma polymer and combinations thereof; and/or
iv) is immobilized on the surface of the layer by a wet chemical process, wherein the wet chemical process is selected from the group consisting of immersion processes, liquid pressure processes, and combinations thereof.

31. The arrangement according to claim 26, wherein the first catalyst
i) is immobilized uniformly distributed on the surface of the layer, optionally with the second catalyst being immobilized uniformly distributed on the surface of the layer and at a certain distance from the first catalyst, or
ii) is immobilized in a first region of the surface of the layer and the second catalyst is immobilized in a second region of the arrangement which is different from the first region of the surface of the layer and which has a distance from the first region of the surface of the layer which is in the range of 1 μm to 20 cm, wherein the second region is optionally a second region on the surface of the layer of the arrangement or a region on a surface of a further layer of the arrangement.

32. The arrangement according to claim 26, wherein the second catalyst
i) is selected from the group consisting of photocatalyst, noble metal catalyst, enzymatic catalyst and organic, non-enzymatic catalyst, and the second catalyst is an enzymatic catalyst; and/or
ii) is a non-particulate catalyst or is a particulate catalyst; and/or
iii) catalyzes a conversion of a reactant, which is a product of a catalysis of the first catalyst, to a product.

33. The arrangement according to claim 26, wherein the second catalyst is immobilized on the front side of the layer.

34. The arrangement according to claim 33, wherein the second catalyst is immobilized on the surface of the layer via
i) at least one non-covalent bond; and/or
ii) at least one covalent bond; and/or
iii) via a spacer, and/or
iv) a wet chemical process.

35. The arrangement according to claim 34, wherein the second catalyst is immobilized on the surface of the layer via at least one non-covalent bond or via a spacer.

36. The arrangement according to claim 35, wherein the second catalyst is immobilized on the surface of the layer by a wet chemical process, wherein the wet chemical process is selected from the group consisting of immersion processes, liquid pressure processes, and combinations thereof.

37. The arrangement according to claim 26, wherein the second catalyst is immobilized on the surface of the layer and/or on a surface of a further layer of the arrangement, wherein the second catalyst is
i) immobilized uniformly distributed on the surface of the layer at a certain distance from the first catalyst, wherein the certain distance from the first catalyst to the second catalyst is in a range from 1 nm to 1000 μm, wherein the distance refers to a distance determined by confocal Raman microscopy or electron microscopy; or
ii) immobilized in a second region of the surface of the layer and the first catalyst is immobilized in a first region of the surface of the layer which is different from the first region of the surface of the layer and which has a distance from the first region of the surface of the layer which is in the range from 1 μm to 20 cm; or
iii) immobilized in a region of a surface of a further layer of the arrangement and the first catalyst is immobilized on the surface of the layer, wherein the region of the surface of the further layer of the arrangement has a distance from the region of the surface of the layer of the arrangement which is in the range from 1 μm to 20 cm.

38. The arrangement according to claim 26, wherein the first catalyst and/or the second catalyst is a particulate catalyst.

39. The arrangement according to claim 26, wherein the first catalyst and/or the second catalyst is a supraparticulate catalyst, wherein the supraparticulate catalyst
i) has a diameter in the range from 1 μm to 20 μm; and/or
ii) comprises a plurality of catalytically active nanoparticles having a diameter in the range from 1 nm to 500 nm; and/or
iii) comprises a plurality of catalytically inactive carrier particles, the surface of which is coated with catalytic particles comprising catalytically active molecules, ions and/or atoms; and/or
iv) comprises a plurality of catalytically active nanoparticles and catalytically inactive carrier particles, the surface of which is coated with catalytic particles comprising catalytically active molecules, ions and/or atoms; and/or
v) is prepared by spray drying.

40. The arrangement according to claim 26, which comprises a liquid contacting the front side of the layer, wherein the liquid
i) comprises water; and/or
ii) comprises oxygen; and/or
iii) comprises a nucleophilic reagent; and/or
iv) comprises a halogenating agent; and/or
v) comprises at least one organic solvent selected from the group consisting of alcohol, DMSO and mixtures thereof; and/or
vi) comprises at least one reactant, optionally several reactants, the conversion of which to a product is catalyzed by the first and/or second catalyst, wherein the at least one reactant is selected from the group consisting of β-keto-carboxylic acid and alkylated benzene; and/or
vii) comprises the second catalyst; and/or
viii) is disposed at a height on the front surface of the layer which is in the range of to 200 μm, the height corresponding to a length from a deepest point of the front side of the layer to a point of the liquid which is furthest from the deepest point of the front side of the layer.

41. The arrangement according to claim 26, which comprises a support frame adapted to support the layer in a reversible manner.

42. The arrangement according to claim 26, which comprises a light source configured to emit light of at least a specific wavelength in the range from 250 nm to 1000 nm in the direction of the front side and/or rear side of the layer, and optionally in the direction of the front side and/or rear side of at least one further layer of the arrangement.

43. A flow reactor, comprising
i) an arrangement according to claim 26;
ii) an inlet for a liquid; and
iii) an outlet for a liquid;
wherein the inlet and outlet are each fluidically connected at least to the front side of the layer.

44. The flow reactor according to claim 43, wherein the first catalyst is immobilized in a first region of the surface of the layer which faces the inlet and the second catalyst is immobilized in a region of the arrangement which faces the outlet and which does not overlap with the first region of the surface of the layer.

45. The flow reactor according to claim 44, wherein the inlet for a liquid is connected to a liquid source, the liquid source containing a liquid, wherein the liquid
i) comprises water; and/or
ii) comprises a nucleophilic reagent; and/or
iii) comprises a halogenating agent; and/or
iv) comprises at least one organic solvent; and/or
v) comprises at least one reactant, the conversion of which to a product is catalyzed by the first and/or second catalyst, wherein the at least one reactant is selected from the group consisting of β-keto-carboxylic acid and alkylated benzene; and/or
vi) comprises the second catalyst.

46. The flow reactor according to claim 43, wherein the flow reactor comprises an inlet for a gas and an outlet for a gas, wherein the inlet for a gas and the outlet for a gas are each fluidically connected at least to the front side of the layer; and/or the inlet for a gas is connected to a gas source that contains in particular oxygen.

47. The flow reactor according to claim 43, wherein the flow reactor has at two to five arrangements, wherein the arrangements are connected fluidically in parallel or fluidically in series in a direction from the inlet to the outlet of the flow reactor; and/or between the respective arrangements, the first and/or second catalysts are the same or different.

48. A method for the catalysis of at least two reactions, comprising:
a) providing an arrangement according to claim 26; and
b) contacting at least the first surface of the layer with a liquid, wherein the liquid comprises at least one reactant whose conversion to a product is catalyzed by the first and second catalysts, or the liquid comprises at least one first reactant, the conversion of which to at least one first product is catalyzed by the first or second catalyst, and the liquid comprises at least one second reactant, the conversion of which to at least one second product is catalyzed by one of the first or second catalysts which does not catalyze the conversion of the first reactant to a first product.

49. The method according to claim 48, wherein the light of at least one specific wavelength in the range from 250 nm to 1000 nm is irradiated in the direction of the front side and/or rear side of the layer, and optionally in the direction of the front side and/or rear side of at least one further layer of the arrangement, the light of the specific wavelength preferably being light of a wavelength required for catalysis of the first and/or second reaction.

50. The method according to claim 48, wherein, in step a), a flow reactor is provided and the liquid is passed from the inlet to the outlet of the flow reactor, wherein the liquid is first passed over the first catalyst which is immobilized in a first region of the surface of the layer which faces the inlet, and the liquid is subsequently passed over the second catalyst which is immobilized in a region of the arrangement which faces the outlet and which does not overlap with the first region of the layer of the arrangement.

51. The method according to claim 48, wherein the flow reactor further comprises at least one inlet for a gas and at least one outlet for a gas, which are each fluidically connected to the front side of the layer and/or to a front side of a further layer of the arrangement, wherein the gas is transported from the inlet for a gas to the outlet for a gas.

52. The method according to claim 48, wherein the flow reactor has two to five arrangements, wherein
i) the arrangements, in a direction from the inlet to the outlet of the flow reactor, are connected fluidically in parallel or fluidically in series and wherein the liquid is transported fluidically in parallel or in series from the inlet for a liquid to the outlet for a liquid and optionally a gas is transported fluidically in parallel or in series from an inlet for a gas of the flow reactor to an outlet for a gas of the flow reactor; and/or
ii) between the respective arrangements, the first and/or second catalysts are the same or different.
